(19) United States
(12) Patent Application Publication
(10) Pub. No.: US 2025/0137295 A1
(43) Pub. Date: May 1, 2025

(54) AUTOMATIC LOCK

(71) Applicant: SmartRent Technologies, Inc., Scottsdale, AZ (US)

(72) Inventors: Sebastian Popovic, Zagreb (HR); Darko Budor, Scottsdale, AZ (US); Tomislav Secen, Zagreb (HR)

(73) Assignee: SmartRent Technologies, Inc., Scottsdale, AZ (US)

(21) Appl. No.: 18/929,472

(22) Filed: Oct. 28, 2024

Related U.S. Application Data
(63) Continuation of application No. PCT/US24/53124, filed on Oct. 25, 2024.
(60) Provisional application No. 63/545,926, filed on Oct. 26, 2023.
(60) Provisional application No. 63/545,930, filed on Oct. 26, 2023.

(51) Int. Cl. E05B 63/00; E05B 15/04; E05B 47/00

(52) U.S. Cl. CPC E05B 63/0017; E05B 15/04; E05B 47/0002; E05B 2047/0017; E05B 2047/002

(57) ABSTRACT

An automatic lock is disclosed. The lock can use a constant power spring to automatically lock itself when unlocked. The door lock can comprise a motor configured to charge a capacitor when a battery is depleted. The door lock can comprise a spindle extending from an exterior portion of the door lock to an interior portion of the door lock, mechanically linked to a key arm and a latch. When engaged, the key arm can allow the spindle to be turned by the exterior knob without actuating the latch, when disengaged, the key arm can allow the spindle to be turned by the exterior knob and actuate the latch.

### CROSS REFERENCE TO RELATED APPLICATIONS

This application is a continuation of PCT Application Number PCT/US24/53124, filed Oct. 25, 2024, and entitled “AUTOMATIC LOCK”. PCT Application Number PCT/US24/53124 claims priority to U.S. Provisional Application No. 63/545,930, filed Oct. 26, 2023, and entitled “AUTOMATIC LOCK”. PCT/US24/53124 also claims priority to U.S. Provisional Application No. 63/545,926, filed Oct. 26, 2023, and entitled “AUTOMATIC LOCK”. PCT Application Number PCT/US24/53124, U.S. Provisional Application No. 63/545,930, and Provisional Application No. 63/545,926 are herein incorporated by this reference in their entirety.

### TECHNICAL FIELD

This disclosure relates generally to locks and more specifically to automatically locking door locks.

### BACKGROUND

Automatic locks generally use a motor to actuate a locking assembly into either an unlocked or locked position. In order to power the motor, automatic locks must have an external power source, such as a hardwire or a battery. Hardwiring door locks in a building can be prohibitively expensive, and, while batteries can provide for a cheaper power source, they also must be recharged or replaced when depleted. Further, battery life can be shortened for locks that use wireless communications because wireless transceivers can have large power requirements. Therefore, there is a need for a door lock that actuates a locking assembly with reduced power requirements.

### SUMMARY

Many embodiments comprise a door lock for automatic locking, with various embodiments configured for locking biased latch bolts. The door lock can comprise an exterior portion, a latch assembly coupled to the exterior portion, and an interior portion coupled to the latch assembly. The interior portion can comprise a constant power spring configured to actuate the latch assembly.

These and other embodiments may optionally include one or more of the following features. The exterior portion can comprise an exterior knob. The interior portion can comprise an interior knob. The door lock can further comprise a spindle extending from the exterior knob, through the latch assembly, and to the interior knob and mechanically linked to the constant power spring. Turning the exterior knob or the interior knob can rotate the spindle and can charge the constant power spring to actuate the latch assembly. The interior portion can comprise a cog mechanically linked to the interior knob or the exterior knob, wherein rotating the cog can charge the constant power spring. The cog can comprise a tooth configured to couple a hooked end of the constant power spring. Rotating the cog can cause the tooth to couple the hooked end of the constant power spring, thereby coiling the constant power spring. Coiling the constant power spring can produce a force in an opposite direction of the rotation of the cog. The exterior portion can comprise a gear assembly mechanically linked to the exterior knob and a dynamo mechanically linked to the gear assembly. The dynamo can comprise an electromagnetic motor configured to convert rotational movement into energy. The energy created by the dynamo can be stored in a capacitor. At least one of the exterior portion and the interior portion can comprise at least one of a circuit board, a motor, a biometric authenticator, an indicator light, and a keypad. The capacitor can provide electrical power to at least one of the circuit board, the motor, the biometric authenticator, the indicator light, and the keypad.

Many embodiments comprise a door lock using a motor and blocking system. The door lock can comprise an exterior portion comprising an exterior knob, a latch assembly coupled to the exterior portion, an interior portion coupled to the latch assembly and comprising the motor and a key arm mechanically linked to the motor, and a spindle extending from the exterior portion to the interior portion and mechanically linked to the key arm and the latch assembly, wherein the key arm, when engaged, allows the spindle to be turned by the exterior knob without actuating the latch assembly and the key arm, when disengaged, allows the spindle to be turned by the exterior knob and actuate the latch assembly.

These and other embodiments may optionally include one or more of the following features. The door lock can comprise a hollow shaft disposed over the spindle and mechanically linked to the latch assembly, the interior portion can comprise an interior knob, the spindle can extend from the exterior knob, through the latch assembly, through the hollow shaft, and to the interior knob, and turning the interior knob can rotate the hollow shaft and actuate the latch assembly regardless of whether the key arm is engaged or the key arm is disengaged. The key arm can be engaged and disengaged by the motor. When disengaged, the key arm can move away from the interior knob. When disengaged, the key arm releases a pin that drops towards and couples the spindle and hollow shaft together. The interior portion can comprise a gear assembly. The gear assembly can comprise a partial gear coupled to the interior knob, a gear mechanically linked to the partial gear and configured to be rotated upon rotating of the interior knob, and a spring housing coupled to the gear and configured to be rotated upon rotating of the gear. The spring housing can comprise a first spring peg coupled to the interior portion, a second spring peg, and a tortional spring, wherein a first end of the tortional spring is coupled to the first spring peg and a second end of the tortional spring is coupled to the second spring peg. Rotation of the spring housing can rotate the second spring peg, thereby stretching the tortional spring. The rotation of the spring housing can cause a protrusion to extend outwardly from the spring housing and engage a pawl, thereby preventing the gear assembly from rotating.

### BRIEF DESCRIPTION OF THE DRAWINGS

To facilitate further description of the embodiments, the following drawings are provided in which:

FIG. 1 illustrates an exterior portion of a door lock, according to an embodiment;

FIG. 2 illustrates an interior portion of a door lock, according to an embodiment;

FIG. 3 illustrates a cutaway view of an exterior portion of a door lock, according to an embodiment;

FIG. 4 illustrates a side cutaway view of an exterior portion of a door lock, according to an embodiment;

FIG. 5 illustrates a cutaway view of an interior portion of a door lock, according to an embodiment;

FIG. 6 illustrates a side cutaway view of an interior portion of a door lock, according to an embodiment;

FIG. 7 illustrates a cutaway view of an interior portion of a door lock, according to an embodiment;

FIG. 8 illustrates a side cutaway view of an interior portion of a door lock, according to an embodiment;

FIG. 9 illustrates a cutaway view of an interior portion of a door lock, according to an embodiment;

FIG. 10 illustrates a cutaway view of an interior portion of a door lock, according to an embodiment;

FIG. 11 illustrates a cutaway view of an interior portion of a door lock, according to an embodiment;

FIG. 12 illustrates an exterior portion of a door lock, according to an embodiment;

FIG. 13 illustrates an interior portion of a door lock, according to an embodiment;

FIG. 14 illustrates a cutaway view of an exterior portion of a door lock, according to an embodiment;

FIG. 15 illustrates a side cutaway view of an exterior portion of a door lock, according to an embodiment;

FIG. 16 illustrates a cutaway view of an interior portion of a door lock, according to an embodiment;

FIG. 17 illustrates a side cutaway view of an interior portion of a door lock, according to an embodiment;

FIGS. 18A-18B illustrates a cutaway views of a drivetrain for a door lock, according to an embodiment; and

FIG. 19 illustrates a cutaway view of a pin used in a door lock, according to an embodiment.

### DESCRIPTION OF EXAMPLES OF EMBODIMENTS

For simplicity and clarity of illustration, the drawing figures illustrate the general manner of construction, and descriptions and details of some features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

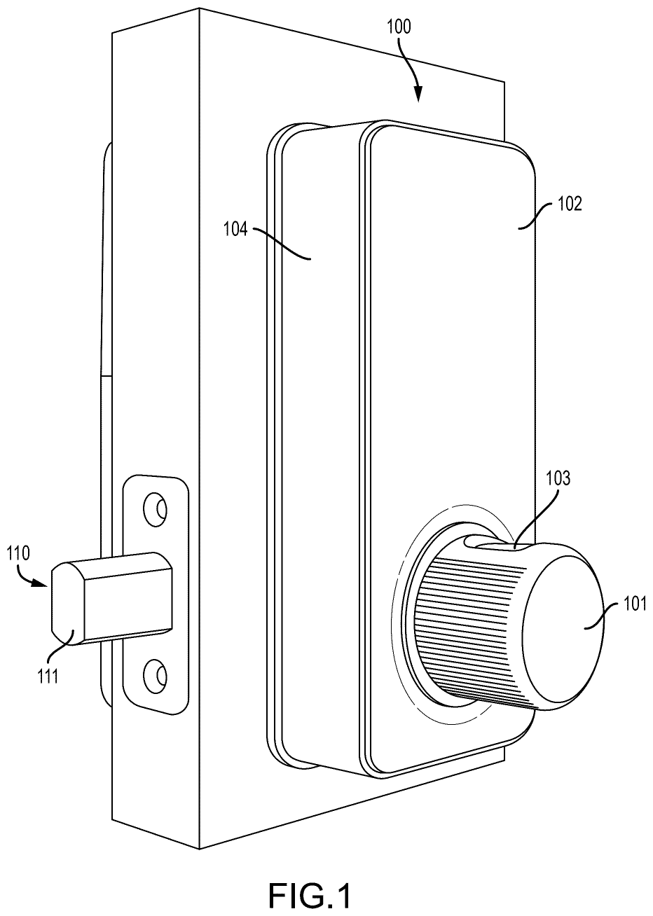

Turning now to the drawings, FIG. 1 shows an exterior portion 100 of a door lock in a locked state. Exterior portion 100 is merely exemplary and is not limited to the embodiments presented herein. Exterior portion 100 can be employed in many different embodiments or examples not specifically depicted or described herein. While exterior portion 100 is shown as a deadbolt style lock in the FIGS., a person having ordinary skill in the art understands that elements of exterior portion 100 can be used with other styles and types of locks. For example, a doorknob style lock, a mortise style lock, a lever lock, and many other lock types can be used in combination with elements of exterior portion 100. One or more elements of exterior portion 100 can be made from a variety of materials depending on the tolerances involved in its function. For example, elements of exterior portion 100 can be made from metal, wood, ceramic, plastic, or some other rigid and/or semi rigid material. Elements of exterior portion 100 can be manufactured in a number of different ways. For example, elements of exterior portion 100 can be die cast, extruded, molded, rolled, bent, or created via some other type of industrial manufacturing process.

Exterior portion 100 can be located on or otherwise adjacent and accessible to an exterior portion of a door and/or be a portion of a lock where actuation of latch assembly 110 can be enabled or disabled. In many embodiments, latch assembly can be enabled by extending latch 111 and disabled by retracting latch 111. The exterior portion 100 can comprise an exterior knob 101, a keypad 102, a biometric authenticator 103, and/or an exterior housing 104. Exterior knob 101 can be coupled and/or mechanically linked with one or more internal elements of exterior portion 100. Exterior knob 101 can take a number of ornamental form factors depending on a lock type used. For example, exterior knob 101 can comprise a doorknob, a lever, or some other structure capable of rotational motion. Keypad 102 and/or biometric authenticator 103 can function to actuate latch assembly 110 upon authentication. The keypad 102 can receive a keycode and/or pattern from a user attempting to unlock exterior portion 100. While keypad 102 is shown as being embedded underneath a front portion of housing 104, a person having ordinary skill in the art will recognize that keypad 102 can also comprise buttons, a touch screen configured to display numbers or shapes, and/or some other type of code entry mechanism. Biometric authenticator 103 can receive biometric data from the user attempting to unlock exterior portion 100. While biometric authenticator 103 is shown as a fingerprint reader, a person having ordinary skill in the art will understand that biometric authenticator can be some other type of biometric authenticator. For example, biometric authenticator can comprise a camera configured to perform a retinal scan or facial recognition. Further, while biometric authenticator 103 is shown as being embedded in a top portion of exterior knob 101, a person having ordinary skill in the art will understand that biometric authenticator 103 can be embedded in other portions of exterior portion 100. For example, biometric authenticator 103 can be embedded in a front portion of exterior knob 101, keypad 102, exterior housing 104, or some other portion of exterior portion 100. Exterior housing 104 can be configured to encase and protect internal components of exterior portion 100. Exterior housing 104 can be configured to engage with one or more seals and/or gaskets to protect the internal components from water damage and dust accumulation. In many embodiments, a radio frequency identification (RFID) tag, antenna, and/or reader may be located underneath one or more of exterior knob 101, keypad 102, biometric authenticator 103, or exterior housing 104. The RFID tag, antenna, and/or reader may be configured to detect an RFID signal and then activate one or more motors within the lock. These motors can actuate one or more mechanisms within the lock, thereby locking or unlocking the lock (depending on what RFID signal is received).

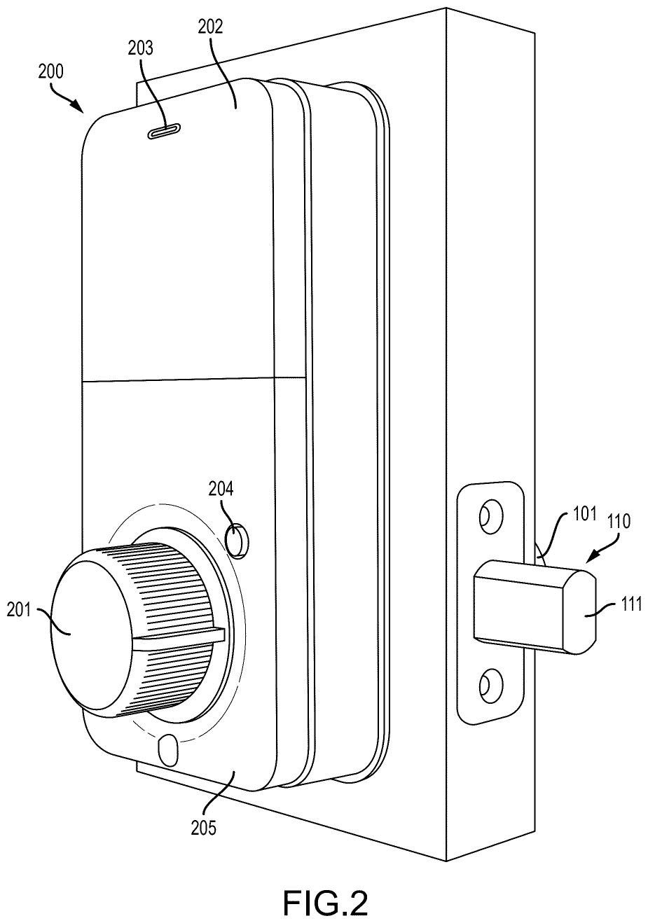

Turning now to FIG. 2, an interior portion 200 of a door lock is shown in a locked state. Interior portion 200 is merely exemplary and is not limited to the embodiments presented herein. Interior portion 200 can be employed in many different embodiments or examples not specifically depicted or described herein. While interior portion 200 is shown as a deadbolt style lock in the FIGS., a person having ordinary skill in the art understands that elements of interior portion 200 can be used with other styles and types of locks. For example, a doorknob style lock, a mortise style lock, a lever lock, and many other lock types can be used in combination with elements of interior portion 200. One or more elements of interior portion 200 can be made from a variety of materials depending on the tolerances involved in its function. For example, elements of interior portion 200 can be made from metal, wood, ceramic, plastic, or some other rigid and/or semi rigid material. Elements of interior portion 200 can be manufactured in a number of different ways. For example, elements of interior portion 200 can be die cast, extruded, molded, rolled, bent, or created via some other type of industrial manufacturing process.

Interior portion 200 can be located on or within an interior portion of a door and/or be a can be a portion of a lock where actuation of latch assembly 110 is enabled. In some embodiments, interior portion 200 always be electronically and/or mechanically coupled to latch assembly 110, thereby allowing the lock to always be opened from the inside. The interior portion 200 can comprise interior knob 201, battery 202, indicator light 203, button 204, and/or interior housing 205. Interior knob 201 can be coupled and/or mechanically linked with one or more internal elements of interior portion 200. In some embodiments, interior knob 201 can always be coupled and/or mechanically linked to latch assembly 110. Interior knob 201 can take a number of ornamental form factors depending on a lock type used. For example, interior knob 201 can comprise a doorknob, a lever, or some other structure capable of rotational motion. Battery 202 can power one or more of exterior portion 100 (FIG. 1) and interior portion 200. Battery 202 can store and transmit electrical energy through many types of electro-chemical reactions. In some embodiments, battery 202 can have an integrated wall socket adapter. The wall socket adapter can comprise a male portion of a wall socket for a specific region. For example, the wall socket adapter can comprise a two prong, three prong, or some other type of wall socket adapter. The wall socket adapter can be used to recharge battery 202 when it is depleted. In various embodiments, the wall socket adapter can be configured to hingedly fold into one or more cervices on a surface of battery 202, In this way, when the wall socket is not in use it can be collapsed so that battery 202 can sit flush on interior portion 200. Indicator light 203 can be configured to provide a status for the lock by displaying one or more different colors. For example, indicator light 203 can display a first color when the lock is locked, a second color when the lock is unlocked, and/or a third color when battery 202 needs to be recharged. Button 204 can be configured to disable one or more authentication credentials for keypad 102 and/or biometric authenticator 103, thereby preventing unauthorized entry. For example, actuating button 204 can engage a privacy mode that disables all authentication credentials except a master and/or administrator credential. Interior housing 205 can be configured to encase and protect internal components of interior portion 200. Interior housing 205 can be configured to engage with one or more seals and/or gaskets to protect the internal components from water damage and dust accumulation.

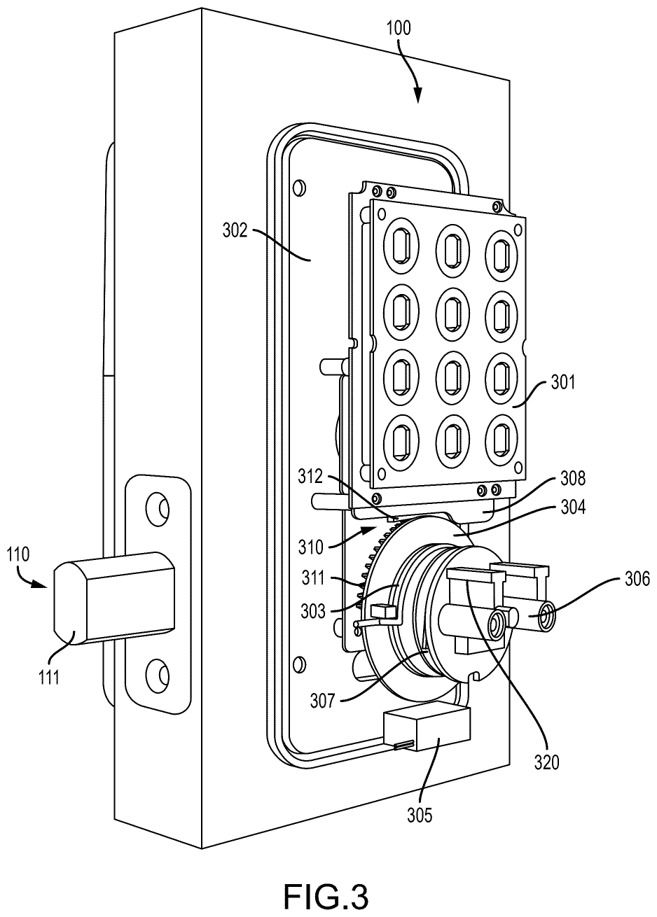

Turning now to FIG. 3, a cutaway view showing an interior compartment of exterior portion 100 is shown in a locked state. Internal components of exterior portion 100 are merely exemplary and are not limited to the embodiments presented herein. Internal components of exterior portion 100 can be employed in many different embodiments or examples not specifically depicted or described herein. Internal components of exterior portion 100 can be made from a variety of materials depending on the tolerances involved in their function. For example, internal components of exterior portion 100 can be made from metal, wood, ceramic, plastic, or some other rigid and/or semi rigid material. The internal components of exterior portion 100 can be manufactured in a number of different ways. For example, internal components of exterior portion 100 can be die cast, extruded, molded, rolled, bent, or created via some other type of industrial manufacturing process.

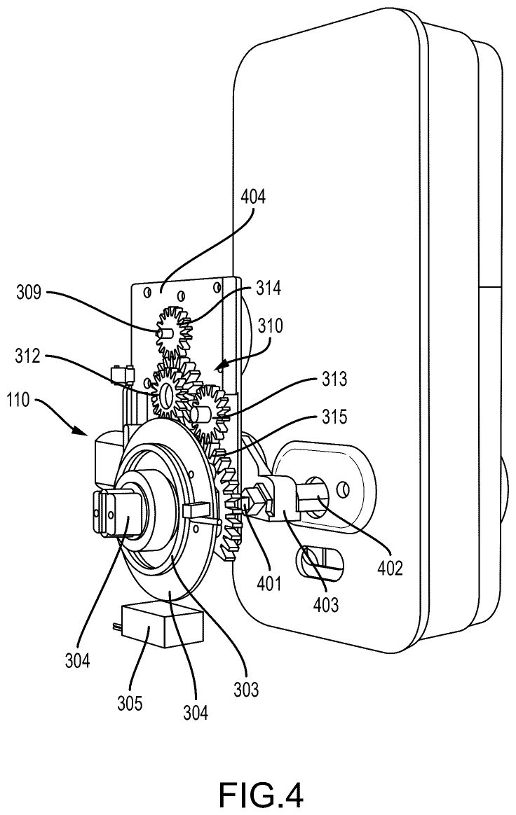

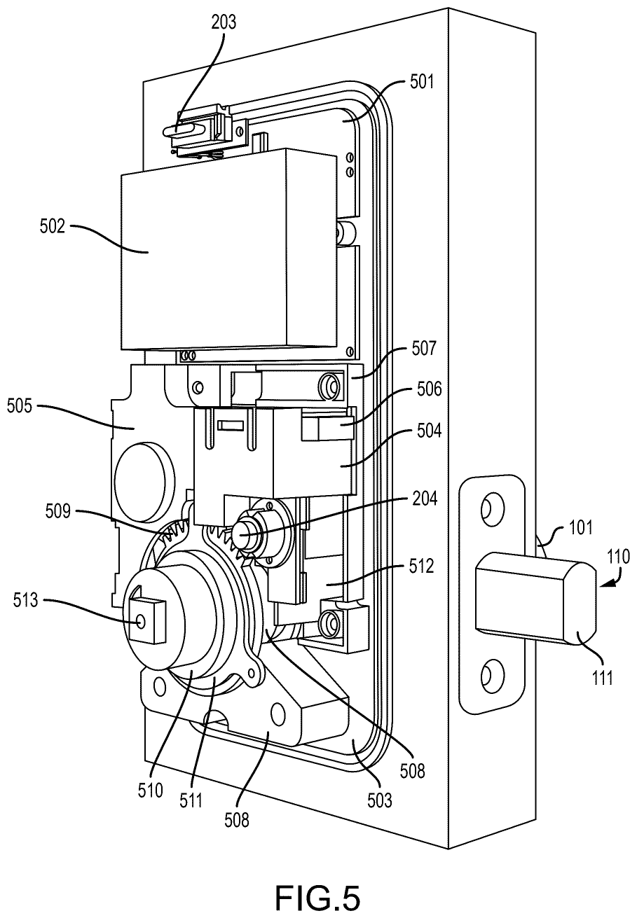

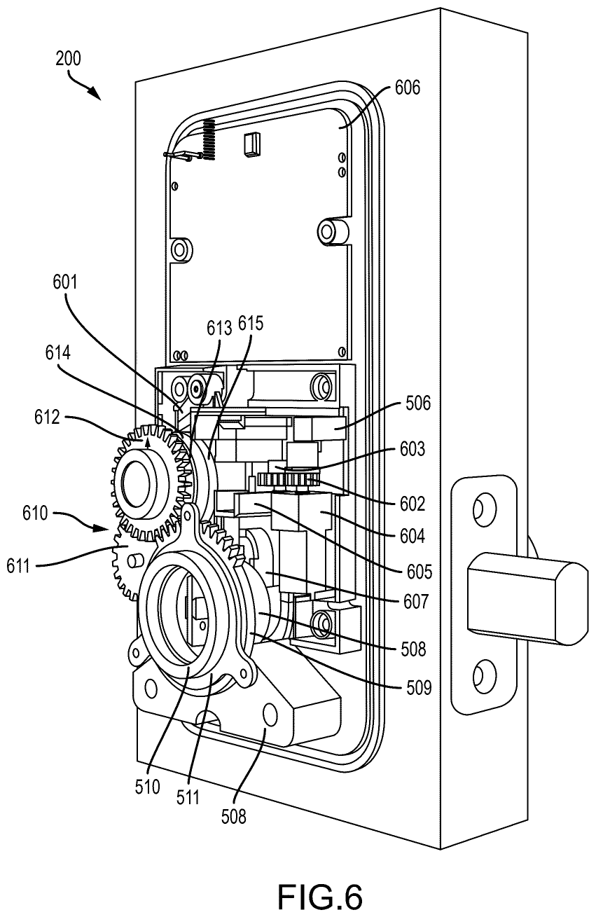

Exterior portion 100 can comprise circuit board 301, back plate 302, tortional spring 303, tortional spring bracket 304, audio emitter 305, knob mounting bracket 306, spacer 307, riser 308, dynamo 309 (FIG. 4), latch assembly 110, and/or gear assembly 310. Gear assembly 310 can comprise gear teeth 311, gears 312-312, and/or gears 313-315 (FIG. 4). Circuit board 301 can be electronically coupled to one or more of knob 101, dynamo 309 (FIG. 4), keypad 102 (FIG. 1), biometric authenticator 103 (FIG. 1), battery 202 (FIG. 2), circuit board 501 (FIG. 5), and/or motor 604 (FIG. 6). In this way, circuit board 301 can draw power and/or transmit electrical signals to various elements of exterior portion 100 and/or interior portion 200. Circuit board 301 can comprise and/or be electronically coupled to a computer system configured to activate, deactivate, and/or control various elements of exterior portion 100 and/or interior portion 200. In some embodiments, one or more elements of a computer system can be embedded in or a part of circuit board 301. For example, circuit board 301 can comprise a processor configured to implement (e.g., run) computer instructions (e.g., program instructions) stored on a memory device. As another example, circuit board 301 can comprise non-volatile memory (e.g., read only memory (ROM)) and/or volatile memory (e.g., random access memory (RAM)). As a final example, circuit board 301 can comprise a network adapter configured to connect exterior portion 100 and/or interior portion 200 to a computer network by wired communication (e.g., a wired network adapter) and/or wireless communication (e.g., a wireless network adapter).

Back plate 302 can comprise a substantially planar bracket suitable for mounting one or more elements of exterior portion 100, supporting one or more elements of exterior portion 100, and/or coupling exterior portion 100 to a surface. The elements of exterior portion 100 can be mounted to back plate 302 using one or more fasteners (e.g., screws, nails, anchors, etc.), adhesive (e.g., glue, epoxy, etc.), or some other mounting or coupling mechanism. Audio emitter 305 can receive audio signals from one or more computer components (e.g., circuit board 301 and/or circuit board 501 (FIG. 5)) and emit various audio signals in accordance with the operation of the lock. For example, audio emitter 305 can emit a noise on locking, unlocking, opening, closing, low battery, and many other lock functions.

Knob mounting bracket 306 can fit within exterior knob 101 and couple to exterior knob 101. In many embodiments, knob mounting bracket 306 can comprise a portion configured to receive electronic components associated with biometric authenticator 103 (FIG. 1). For example, knob mounting bracket 306 comprises one or more posts 320 configured to couple elements of biometric authenticator 103 (FIG. 1). Spacer 307 can be substantially circular and be configured to couple in between mounting bracket 306 and tortional spring bracket 304. In this way, one or more of bracket 306 and tortional spring bracket 304 can be rotated without damaging tortional spring 303. Riser 308 can comprise a substantially flat surface raised by one or more legs. The riser 308 can be configured to support and/or provide a mounting surface for circuit board 301 and other internal elements of exterior portion 100. Additional internal elements of exterior portion 100 can be located underneath riser 308. For example, elements of gear assembly 310 can be underneath riser 308.

Turning now to FIG. 4, a side view of an interior compartment of exterior portion 100 is shown in a locked state. Spindle 401 can extend between and through one or more of interior portion 200 and exterior portion 100. In some embodiments, spindle 401 can pass through latch assembly 110 and/or gear assembly 310 without engaging latch assembly 110 and/or gear assembly 310, as described in greater detail below. Hollow shaft 402 can be disposed over the spindle 401 and/or spindle 401 can pass through an approximate center of hollow shaft 402. In some embodiments, hollow shaft 402 can end before entering a back side of exterior portion 100. The hollow shaft 402 can engage latch assembly 110 and/or gear assembly 310 by passing through a spindle opening in latch assembly 110 and/or gear assembly 310. In this way, when hollow shaft 402 is rotated (e.g., by interior knob 201 (FIG. 2), latch assembly 110 and/or gear assembly 310 can be actuated. While hollow shaft 402 can surround all or a portion of spindle 401, both hollow shaft 402 and spindle 401 can rotate independently of each other when latch assembly 110 is in a locked configuration. In this way, exterior knob 101 (FIG. 1) and spindle 401 can be rotated without shifting latch assembly 110 into an unlocked position, thereby enhancing a security of the lock. Exterior knob 101 (FIG. 1) and/or knob mounting bracket 306 (FIG. 3) can be coupled and/or mechanically linked to one or more of tortional spring 303 and tortional spring bracket 304. When exterior knob 101 (FIG. 1) is rotated in either direction, this motion can be transferred to tortional spring bracket 304. Tortional spring bracket 304 is coupled to tortional spring 303 and/or tortional spring 303 is immobilized on a top surface of tortional spring bracket 304. In this way, mechanical energy is stored in tortional spring 303 when exterior knob 101 (FIG. 1) is rotated. When exterior knob 101 (FIG. 1) is released, this stored mechanical energy can then be released by tortional spring 303, thereby causing exterior knob 101 (FIG. 1) to return to its original position.

Exterior knob 101 (FIG. 1) can also be coupled and/or mechanically linked to gear assembly 310. In some embodiments, spindle 401 facilitates this coupling or mechanical linkage by being passed through one or more elements of gear assembly 310. Gear assembly 310 can be configured to rotate and/or charge dynamo 309 by transferring energy generated by the rotational motion of external knob 101 (FIG. 1) to dynamo 309. Gear teeth 311 and/or one or more of gears 312-316 can mechanically link and/or couple together to transfer rotational motion and energy. While gear teeth 311 is shown in a crown gear and gears 312-316 are shown as spur gears, a person having ordinary skill in the art will understand that a variety of gear types can be used in gear assembly 310. For example, helical gears, bevel gears miter gears, worm gears, screw gears, and many other types of gears can be used in gear assembly 310. In many embodiments, gear teeth 311 (FIG. 3) and/or gear 315 can be coupled to and/or integrated with an underside of tortional spring bracket 304. In many embodiments, gear teeth 311 (FIG. 3) and/or gear 315 can be located along a periphery of tortional spring bracket 304. In this way, when external knob 101 is rotated, gear assembly 310 can actuate dynamo 309 enough to charge the dynamo 309 without damaging it. Multi-level gear 312 can have one or more levels of gear teeth configured to couple and/or mechanically link with different gears. For example, multi-level gear 312 can have an upper, middle, and lower set of teeth. Each level of teeth on multi-level gear 312 can have a different radius. For example, an upper set of teeth can have a smaller radius than a middle set of teeth.

Gear teeth 311 can be coupled and/or mechanically linked to gear 312 such that, when gear teeth 311 are rotated (e.g., by rotating exterior knob 101 (FIG. 1) clockwise), gear 312 also rotates. Gear 312 can, in turn, be coupled and/or mechanically linked to gear 314 such that, when gear 312 is rotated (e.g., by rotating external knob 101 (FIG. 1) clockwise), gear 314 (and therefore dynamo 309) also rotates. Gear 315 can be coupled and/or mechanically linked to gear 313 such that, when gear 315 is rotated (e.g., by rotating external knob 101 (FIG. 1) counterclockwise), gear 313 also rotates. Gear 313 can, in turn, be coupled and/or mechanically linked to gear 312 such that, when gear 312 is rotated (e.g., by rotating external knob 101 (FIG. 1) counterclockwise), gear 314 (and therefore dynamo 309) also rotates. Gear ratios among gear teeth 311 and gears 312-315 can allow gear 314 to rotate 5 to 10 times with a half turn of external knob 101 (FIG. 1). Dynamo 309 can comprise an electrical energy generating device capable of converting mechanical energy into electrical energy. In many embodiments, dynamo 309 can comprise an electromagnetic motor and/or a solenoid capable of converting movement into electricity. For example, a rotational portion of dynamo 309 can be coupled to gear 314. In this embodiment, when gear 314 is actuated via turning of external knob 101 (FIG. 1), the rotational portion of dynamo 309 can also rotate, thereby generating an electrical charge in an energy storage portion of an energy storage device (e.g., battery 202 (FIG. 2) or a capacitor electronically coupled to dynamo 309). This stored energy can then be used to power electrical elements of interior portion 200 and/or exterior portion 100 when onboard energy storage devices (e.g., battery 202 (FIG. 2)) are depleted or when a hardwired energy source is down.

Turning now to FIG. 5, a cutaway view showing an interior compartment of interior portion 200 is shown in a locked state. Internal components of interior portion 200 are merely exemplary and are not limited to the embodiments presented herein. Internal components of interior portion 200 can be employed in many different embodiments or examples not specifically depicted or described herein. Internal components of interior portion 200 can be made from a variety of materials depending on the tolerances involved in their function. For example, internal components of interior portion 200 can be made from metal, wood, ceramic, plastic, or some other rigid and/or semi rigid material. The internal components of interior portion 200 can be manufactured in a number of different ways. For example, internal components of interior portion 200 can be die cast, extruded, molded, rolled, bent, or created via some other type of industrial manufacturing process.

Interior portion 200 can comprise circuit board 501, battery 502, back plate 503, housing 504, housing 505, push plate 506, mounting brackets 507-508, partial gear 509, spacer 510, faster 511, housing 512, and/or knob mounting bracket 513. Circuit board 501 can be similar to circuit board 301 (FIG. 3) in function and structure. In many embodiments, one or elements of a computer system can be split between circuit board 301 (FIG. 3) and circuit board 501. For example, a processor can be located on circuit board 301 (FIG. 3) and a memory storage device can be located on circuit board 501. Battery 502 can be housed within battery 202 (FIG. 2). In some embodiments, multiple batteries 502 can be housed within battery 202 (FIG. 2). Back plate 503 can comprise a substantially planar bracket suitable for mounting one or more elements of interior portion 200, supporting one or more elements of interior portion 200, and/or coupling interior portion 200 to a surface. The elements of interior portion 200 can be mounted to back plate 503 using one or more fasteners (e.g., screws, nails, anchors, etc.), adhesive (e.g., glue, epoxy, etc.), or some other mounting or coupling mechanism.

Housings 504-505 and 512 can surround, secure, and/or protect compartments within interior portion 200 containing moving parts. For example, housing 504 can protect gears 602-603 (FIG. 6). Mounting bracket 507 can comprise a substantially planar bracket suitable for mounting one or more elements of interior portion 200, supporting one or more elements of interior portion 200, and/or coupling interior portion 200 to a surface. The elements of interior portion 200 can be mounted to mounting bracket 507 using one or more fasteners (e.g., screws, nails, anchors, etc.), adhesive (e.g., glue, epoxy, etc.), or some other mounting or coupling mechanism. Mounting bracket 508 can have a partially triangular shape with a circular aperture therethrough suitable for mounting and/or stabilizing one or more rotational elements within interior portion 200. For example, mounting bracket 508 is secured to back plate 503 via its bottom triangular portion while the upper aperture receives various elements of a locking mechanism and knob mounting bracket 513. For example, mounting bracket 508 can receive key arm receiver 607 (FIG. 6) and prevent it from rotating more than 90 degrees from its neutral position. This, in turn, prevents knob mounting bracket 513 from rotating and therefore prevents retraction of latch 111 (FIG. 1) without actuation of pawl 601. Mounting bracket 508 also prevents an unauthorized user from brute forcing the lock due to its structural integrity. If exterior knob 101 is forcibly turned, spindle 401 (FIG. 4) will break prior to mounting bracket 508, thereby rendering the lock inoperable. Spacer 510 can sit on top of fastener 511 and/or around knob mounting bracket 513. In this way, sufficient space can be made between interior knob 201 and non-moving portions of interior portion 200 Fastener 511 can assist in coupling partial gear 509 to bracket 508 without impeding the rotational motion of partial gear 509.

Turning now to FIG. 6, a cutaway view showing an interior compartment of interior portion 200 is shown in a locked state. Motor 604 can sit underneath housings 504 and/or 512. The motor 604 can be configured to rotate gear 602. Gear 602, in turn, will rotate gear 603. The gear 603 can comprise at least one elongated tooth. The at least one elongated tooth on gear 603 can, when rotated toward a front of interior portion 200, engage with key arm 605 and push it forward. Further, when gear 602 is rotated, it pushes push plate 506 out of housing 504 (FIG. 5), thereby disengaging pawl 601 from spring housing 614 and allowing gear assembly 610 to actuate. In some embodiments, motor 604 can be activated by electrical signals from one or more of circuit board 301 (FIG. 3) and/or circuit board 606. For example, when a user unlocks a door using keypad 102 (FIG. 1) or biometric authenticator 103 (FIG. 1), one or more of circuit board 301 (FIG. 3) and circuit board 606 can transmit an electrical signal activating motor 604 and pushing key arm 605 forward.

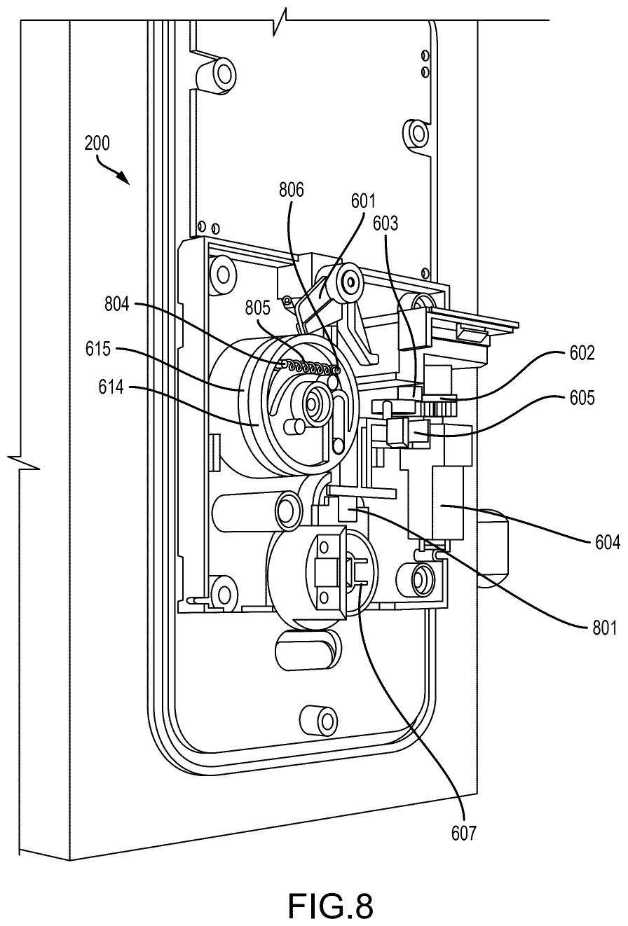

Movement of key arm 605 can cause a coupling and/or mechanical linkage between spindle 401 (FIG. 4) and hollow shaft 402 (FIG. 4), thereby allowing external knob 101 (FIG. 1) to unlock the lock by retracting latch 111. Key arm 605 can be moved forward towards or back away from internal knob 201 (FIG. 2), thereby removing it from key arm receiver 607. In many embodiments, moving key arm 605 towards internal knob 201 (FIG. 2) can release a pin 801 (FIG. 8) previously coupled to key arm receiver 607. Once released, the pin 801 (FIG. 8) can drop down towards spindle 401 (FIG. 4) and hollow shaft 402 (FIG. 4). This pin 801 (FIG. 8) can couple spindle 401 (FIG. 4) and hollow shaft 402 (FIG. 4) so that they rotate together. In this way, a lock can be unlocked and/or disengaged by rotating external knob 101 (FIG. 1), which in turn rotates spindle 401 (FIG. 4) and hollow shaft 402 (FIG. 4). When the lock is transitioned from an unlocked configuration into a locked configuration, key arm 605 can move back away from internal knob 201, thereby removing the pin 801 (FIG. 8) coupling spindle 401 (FIG. 4) and hollow shaft 402 (FIG. 4) together and allowing them to rotate independently again.

Internal knob 201 (FIG. 2) can also be mechanically linked and/or coupled to gear assembly 610. In many embodiments, gear assembly 610 can comprise one or more of partial gear 509, gears 611-613, spring housing 614, and/or spring peg 615. Partial gear 509 can have teeth covering only a portion of its circumference while the remainder of the circumference has no teeth. The rotation of gears in gear assembly 610 can be configured to rotate spring housing 614 and spring peg 615 by transferring energy generated by the rotational motion of internal knob 201 to these components. Gears 611-613 can mechanically link and/or couple together to transfer this rotational motion and energy. While gears 611-613 are shown as spur gears, a person having ordinary skill in the art will understand that a variety of gear types can be used in gear assembly 610. For example, helical gears, bevel gears miter gears, worm gears, screw gears, and many other types of gears can be used in gear assembly 610. Partial gear 509 can actuate two different geared mechanisms depending on which way it rotates. If partial gear 509 is turned counterclockwise (e.g., by rotating interior knob 201), then it will rotate gear 611, which in turn will rotate gear 613. If partial gear 509 is turned clockwise (e.g., by rotating internal knob 201), then gear 612 will rotate. Gear 612 can, in turn, be coupled and/or mechanically linked to gear 613 such that, when gear 521 is rotated (e.g., by rotating internal knob 201), gear 613 also rotates. In some embodiments, gears 612 and 613 can be coupled together on their faces so that they rotate together.

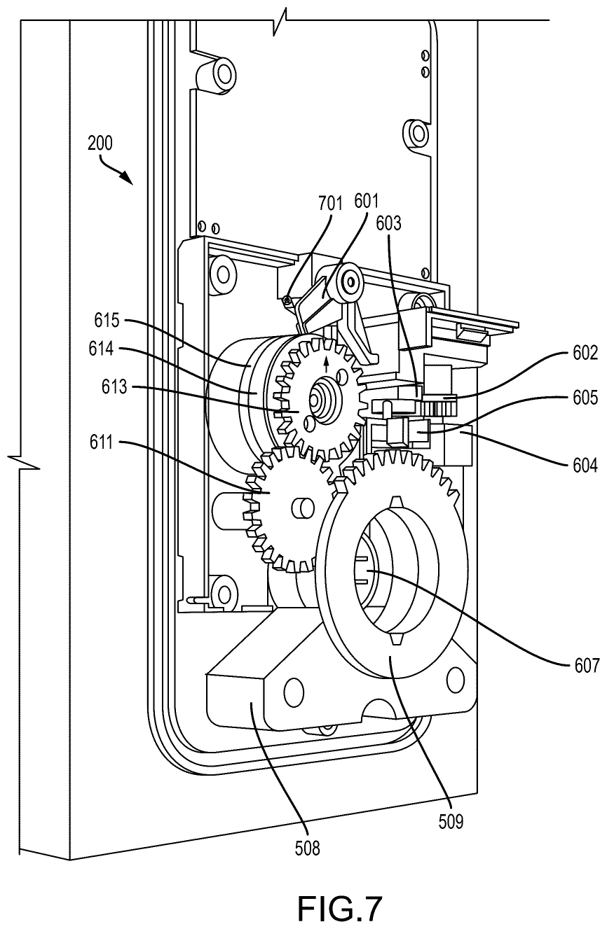

Turning now to FIG. 7, a cutaway view showing an interior compartment of interior portion p is shown in a locked state. Gear 613 can have one or more apertures in it for receiving elements of and/or coupling to gear 612. For example, gear 613 has two exterior apertures to receive pegs present on an underside of gear 612.

Turning now to FIG. 8, a cutaway view showing an interior compartment of interior portion 200 is shown in a locked state. Spring housing 614 can comprise peg 806 and tortional spring 805. Spring housing can also comprise a number of apertures configured to receive other elements of gear assembly 610 (FIG. 6). For example, peg 804 of spring peg 615 can be inserted through spring housing 614. In many embodiments, pegs 804 and 806 can have tortional spring 805 spread between them.

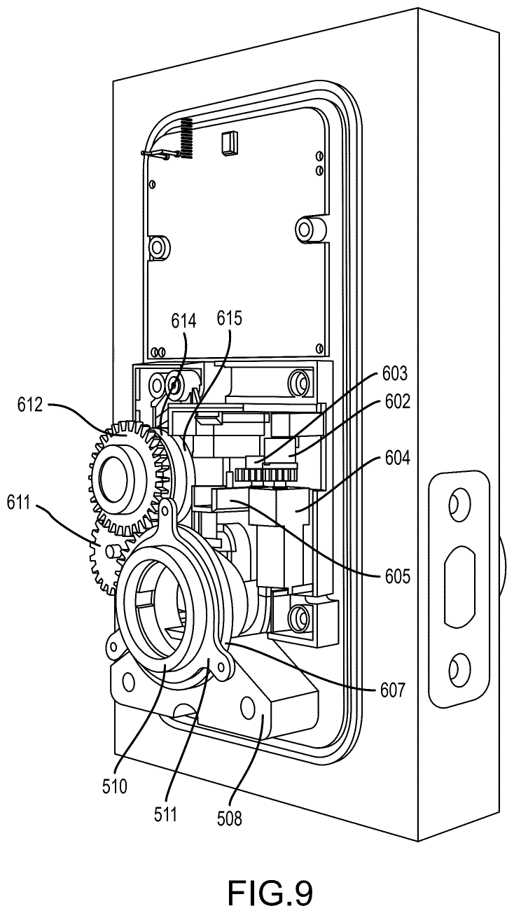

Turning now to FIG. 9, a cutaway view showing an interior compartment of interior portion 200 is shown in an unlocked state. Interior portion 200 can undergo a number of conformational changes when in an unlocked state. For example, gears 603, 611, and 612 have been rotated. As another example, key arm 605 has been moved forward. As a further example, pawl 601 has been engaged and impeding movement of gear assembly 610.

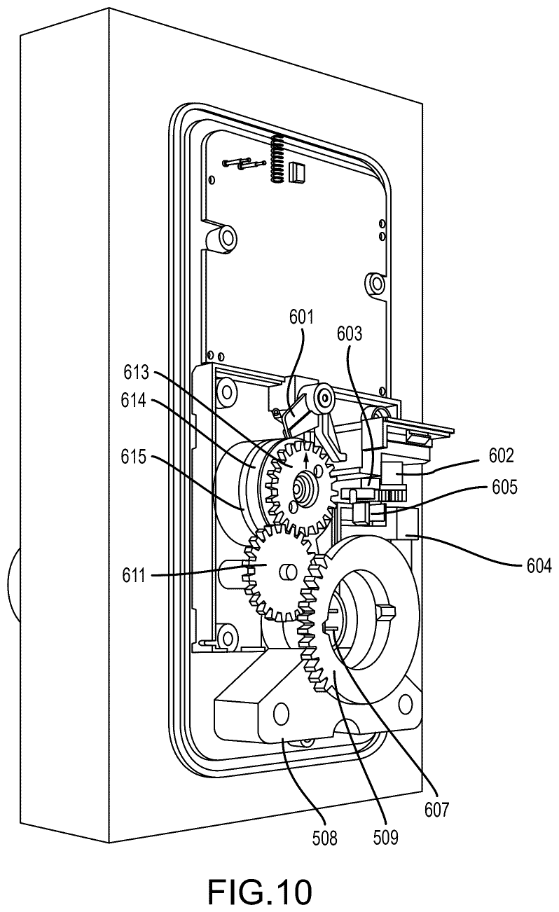

Turning now to FIG. 10, a cutaway view showing an interior compartment of interior portion 200 is shown in an unlocked state. Interior portion 200 can undergo a number of conformational changes when in an unlocked state. For example, gears 603, 611, and 612 have been rotated. As another example, key arm 605 has been moved forward. As a further example, pawl 601 has been engaged and impeding movement of gear assembly 610.

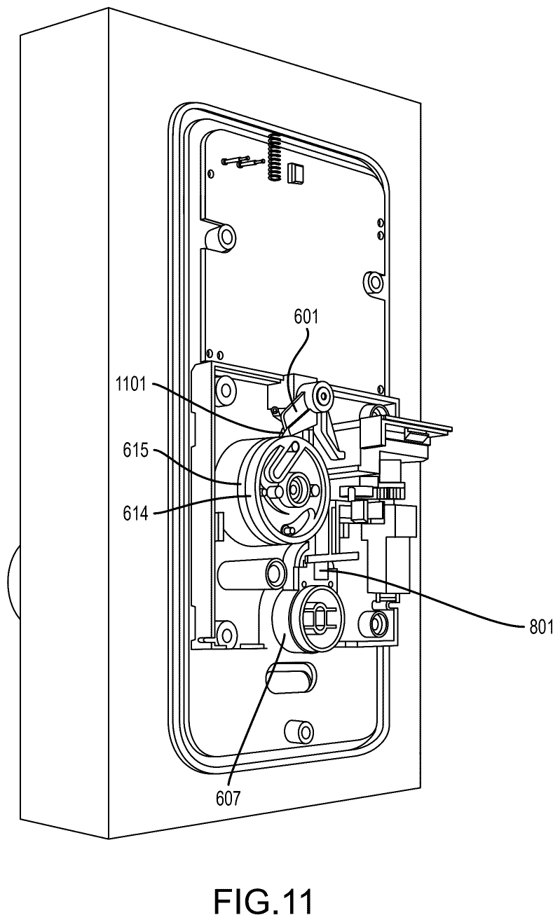

Turning now to FIG. 11, a cutaway view showing an interior compartment of interior portion 200 is shown. Interior portion 200 can undergo a number of conformational changes when in an unlocked state. For example, after being rotated, the interaction between spring housing 614 and spring peg 615 causes protrusion 1101 to extend out of spring peg 615. Protrusion 1101 acts to engage pawl 601 and prevent gear assembly 610 (FIG. 6) from rotating.

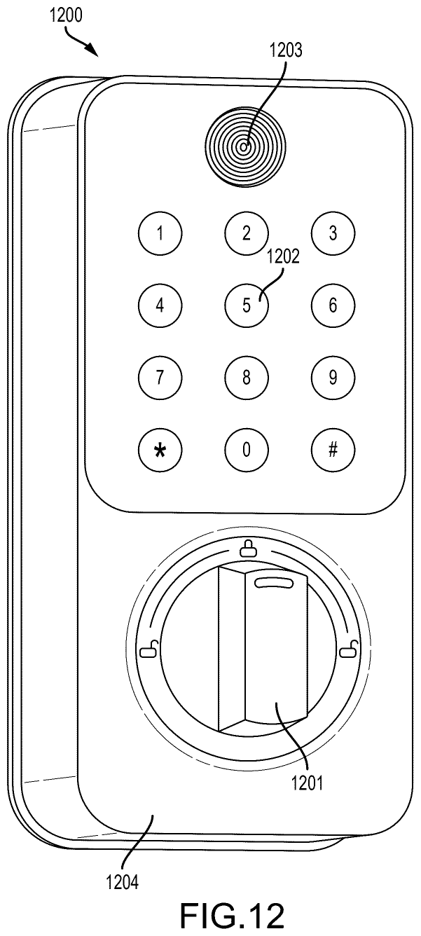

Turning now FIG. 12, an exterior portion 1200 of a door lock is shown. Exterior portion 1200 is merely exemplary and is not limited to the embodiments presented herein. Exterior portion 1200 can be employed in many different embodiments or examples not specifically depicted or described herein. While exterior portion 1200 is shown as a deadbolt style lock in the FIGS., a person having ordinary skill in the art understands that elements of exterior portion 1200 can be used with other styles and types of locks. For example, a doorknob style lock, a mortise style lock, a lever lock, and many other lock types can be used in combination with elements of exterior portion 1200. One or more elements of exterior portion 1200 can be made from a variety of materials depending on the tolerances involved in its function. For example, elements of exterior portion 1200 can be made from metal, wood, ceramic, plastic, or some other rigid and/or semi rigid material. Elements of exterior portion 1200 can be manufactured in a number of different ways. For example, elements of exterior portion 1200 can be die cast, extruded, molded, rolled, bent, or created via some other type of industrial manufacturing process.

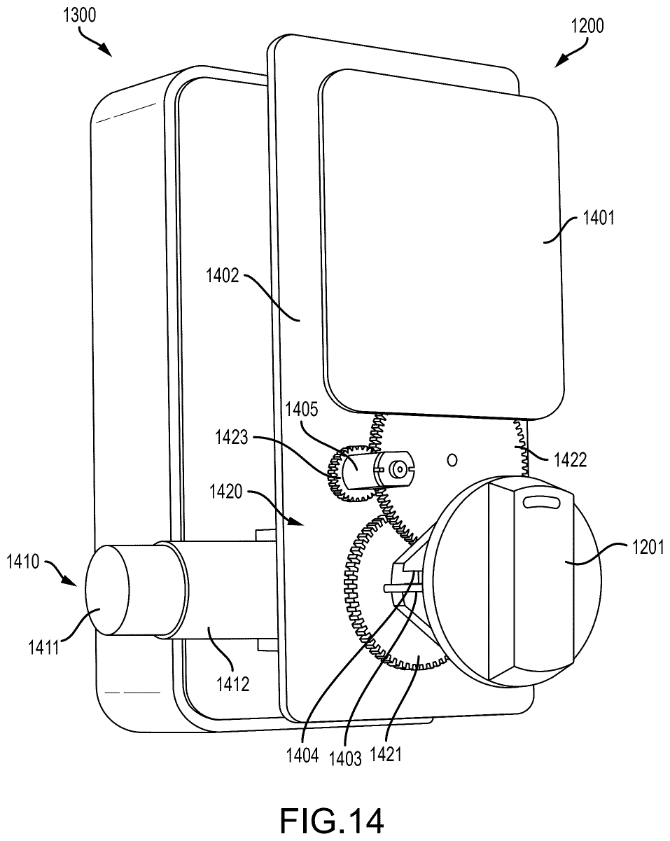

Exterior portion 1200 can be located on or otherwise adjacent and accessible to an exterior portion of a door and/or be a portion of a lock where actuation of latch assembly 1410 (FIG. 14) can be enabled or disabled. The exterior portion 1200 can comprise an exterior knob 1201, a keypad 1202, a biometric authenticator 1203, and/or an exterior housing 1204. Exterior knob 1201 can be coupled and/or mechanically linked with one or more internal elements of exterior portion 1200. Exterior knob 1201 can take a number of ornamental form factors depending on a lock type used. For example, exterior knob 1201 can comprise a doorknob, a lever, or some other structure capable of rotational motion. Keypad 1202 and/or biometric authenticator 1203 can function to actuate latch assembly 1410 (FIG. 14) upon authentication. The keypad 1202 can receive a keycode and/or pattern from a user attempting to unlock exterior portion 1200. While keypad 1202 is shown as having individual areas for each number, a person having ordinary skill in the art will recognize that keypad 1202 can also comprise a touch screen configured to display numbers or shapes, and/or some other type of code entry mechanism. Biometric authenticator 1203 can receive biometric data from the user attempting to unlock exterior portion 1200. While biometric authenticator 1203 is shown as a fingerprint reader, a person having ordinary skill in the art will understand that biometric authenticator can be some other type of biometric authenticator. For example, biometric authenticator can comprise a camera configured to perform a retinal scan or facial recognition. Exterior housing 1204 can be configured to encase and protect internal components of exterior portion 1200. Further, while biometric authenticator 1203 is shown as being embedded above keypad 1202, a person having ordinary skill in the art will understand that biometric authenticator 1203 can be embedded in other portions of exterior portion 1200. For example, biometric authenticator 1203 can be embedded in a front portion of exterior knob 1201, keypad 1202, exterior housing 1204, or some other portion of exterior portion 1200. Exterior housing 1204 can be configured to engage with one or more seals and/or gaskets to protect the internal components from water damage and dust accumulation. In many embodiments, a radio frequency identification (RFID) tag, antenna, and/or reader may be located underneath one or more of exterior knob 1201, keypad 1202, biometric authenticator 1203, or exterior housing 1204. The RFID tag, antenna, and/or reader may be configured to detect an RFID signal and then activate one or more motors within the lock. These motors can actuate one or more mechanisms within the lock, thereby locking or unlocking the lock (depending on what RFID signal is received).

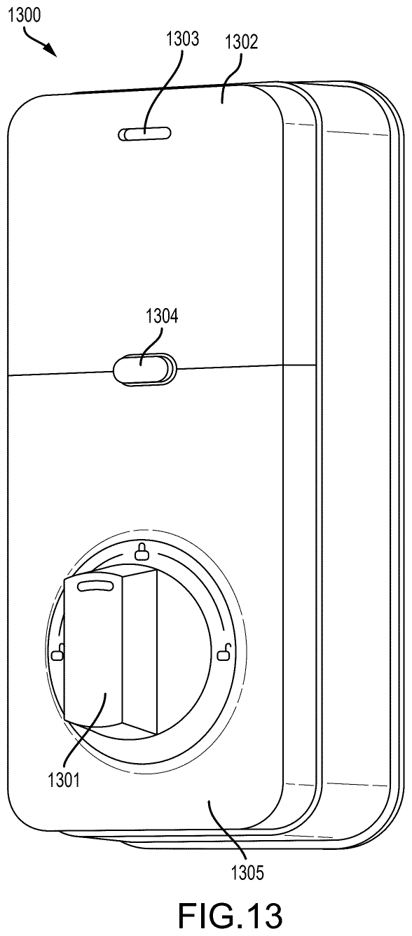

Turning now to FIG. 13, an interior portion 1300 of a door lock is shown. Interior portion 1300 is merely exemplary and is not limited to the embodiments presented herein. Interior portion 1300 can be employed in many different embodiments or examples not specifically depicted or described herein. While interior portion 1300 is shown as a deadbolt style lock in the FIGS., a person having ordinary skill in the art understands that elements of interior portion 1300 can be used with other styles and types of locks. For example, a doorknob style lock, a mortise style lock, a lever lock, and many other lock types can be used in combination with elements of interior portion 1300. One or more elements of interior portion 1300 can be made from a variety of materials depending on the tolerances involved in its function. For example, elements of interior portion 1300 can be made from metal, wood, ceramic, plastic, or some other rigid and/or semi rigid material. Elements of interior portion 1300 can be manufactured in a number of different ways. For example, elements of interior portion 1300 can be die cast, extruded, molded, rolled, bent, or created via some other type of industrial manufacturing process.

Interior portion 1300 can be located on or within an interior portion of a door and/or be a can be a portion of a lock where actuation of latch assembly 1410 (FIG. 14) is enabled. In some embodiments, interior portion 1300 always be electronically and/or mechanically coupled to latch assembly 1410 (FIG. 14), thereby allowing the lock to always be opened from the inside. The interior portion 1300 can comprise interior knob 1301, battery 1302, indicator light 1303, battery release 1304, and/or interior housing 1305. Interior knob 1301 can be coupled and/or mechanically linked with one or more internal elements of interior portion 1300. In some embodiments, interior knob 1301 can always be coupled and/or mechanically linked to latch assembly 1410 (FIG. 14). Interior knob 1301 can take a number of ornamental form factors depending on a lock type used. For example, interior knob 1301 can comprise a doorknob, a lever, or some other structure capable of rotational motion. Battery 1302 can power one or more of exterior portion 1200 (FIG. 12) and interior portion 1300. Battery 1302 can store and transmit electrical energy through many types of electro-chemical reactions. In some embodiments, battery 1302 can have an integrated wall socket adapter. The wall socket adapter can comprise a male portion of a wall socket for a specific region. For example, the wall socket adapter can comprise a two prong, three prong, or some other type of wall socket adapter. The wall socket adapter can be used to recharge battery 1302 when it is depleted. In various embodiments, the wall socket adapter can be configured to hingedly fold into one or more cervices on a surface of battery 1302, In this way, when the wall socket is not in use it can be collapsed so that battery 1302 can sit flush on interior portion 1300. Indicator light 1303 can be configured to provide a status for the lock by displaying one or more different colors. For example, indicator light 1303 can display a first color when the lock is locked, a second color when the lock is unlocked, and/or a third color when battery 1302 needs to be recharged. Battery release 1304 can be configured to lock battery 1302 in place. Battery 1302 can be uncoupled from interior portion 1300 by depressing battery release 1304 and removing battery 1302 from the lock. Interior housing 1305 can be configured to encase and protect internal components of interior portion 1300. Interior housing 1305 can be configured to engage with one or more seals and/or gaskets to protect the internal components from water damage and dust accumulation.

Turning now to FIG. 14, a cutaway view showing an interior compartment of exterior portion 1200 is shown. Internal components of exterior portion 1200 are merely exemplary and are not limited to the embodiments presented herein. Internal components of exterior portion 1200 can be employed in many different embodiments or examples not specifically depicted or described herein. Internal components of exterior portion 1200 can be made from a variety of materials depending on the tolerances involved in their function. For example, internal components of exterior portion 1200 can be made from metal, wood, ceramic, plastic, or some other rigid and/or semi rigid material. The internal components of exterior portion 1200 can be manufactured in a number of different ways. For example, internal components of exterior portion 1200 can be die cast, extruded, molded, rolled, bent, or created via some other type of industrial manufacturing process.

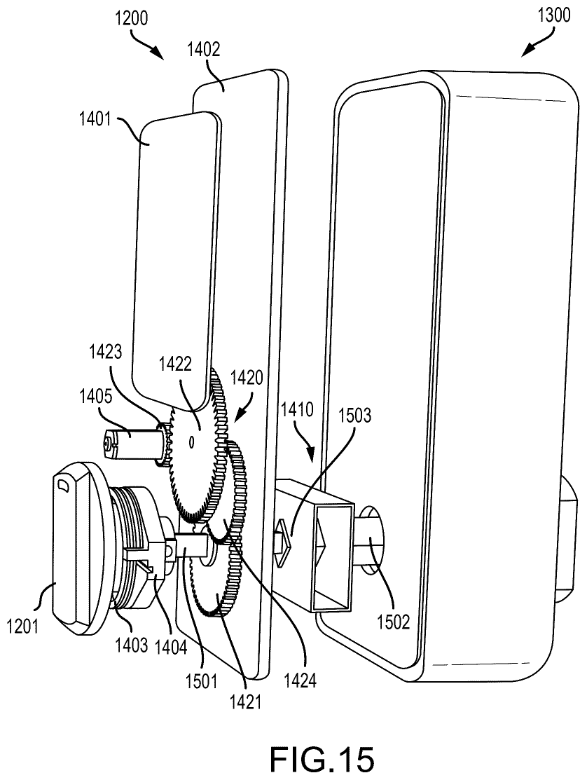

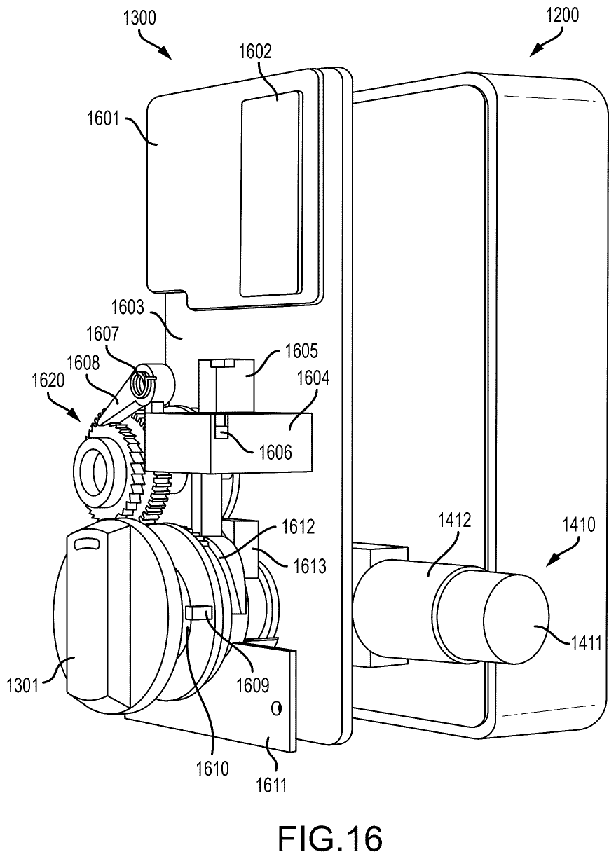

Exterior portion 1200 can comprise circuit board 1401, back plate 1402, tortional spring 1403, tortional spring bracket 1404, latch assembly 1410, and/or gear assembly 1420. Gear assembly 1420 can comprise gears 1421-1423 and/or gear 1424 (FIG. 15). Circuit board 1401 can be electronically coupled to one or more of exterior knob 1201, dynamo 1405, keypad 1202 (FIG. 12), biometric authenticator 1203 (FIG. 12), battery 1302 (FIG. 13), circuit board 1601 (FIG. 16), battery 1602 (FIG. 16), and/or motor 1605 (FIG. 16). In this way, circuit board 1401 can draw power and/or transmit electrical signals to various elements of exterior portion 1200 and/or interior portion 1300. Circuit board 1401 can comprise and/or be electronically coupled to a computer system configured to activate, deactivate, and/or control various elements of exterior portion 1200 and/or interior portion 1300. In some embodiments, one or more elements of a computer system can be embedded in or a part of circuit board 1401. For example, circuit board 1401 can comprise a processor configured to implement (e.g., run) computer instructions (e.g., program instructions) stored on a memory device. As another example, circuit board 1401 can comprise non-volatile memory (e.g., read only memory (ROM)) and/or volatile memory (e.g., random access memory (RAM)). As a final example, circuit board 1401 can comprise a network adapter configured to connect exterior portion 1200 and/or interior portion 1300 to a computer network by wired communication (e.g., a wired network adapter) and/or wireless communication (e.g., a wireless network adapter). Back plate 1402 can comprise a substantially planar bracket suitable for mounting one or more elements of exterior portion 1200, supporting one or more elements of exterior portion 1200, and/or coupling exterior portion 1200 to a surface. The elements of exterior portion 1200 can be mounted to back plate 1402 using one or more fasteners (e.g., screws, nails, anchors, etc.), adhesive (e.g., glue, epoxy, etc.), or some other mounting or coupling mechanism. Latch assembly 1410 can comprise latch 1411 and latch housing 1412. The latch assembly 1410 can be spring loaded, thereby allowing latch 1411 to return to an engaged position after being disengaged (e.g., depressed). In many embodiments, latch assembly 1410 can be similar to a latch assembly in a traditional lock. For example, latch 1411 by pulled into a disengaged position via a transmission plate actuated by one or more cam drive units. These cam drive units can be threaded over one or more of spindle 1501 (FIG. 15) and/or hollow shaft 1502 (FIG. 15), thereby allowing latch assembly 1410 to be actuated by one or more of exterior knob 1201 and/or interior knob 1301 (FIG. 13). In many embodiments, elements of latch assembly 1410 can magnetized to effectuate actuation of latch 1411. For example, latch 1411 can be made of a magnetic material and a latch receiving portion of a door frame can be magnetized to pull latch 1411 out of latch housing 1412 and into the latch receiving portion.

Turning now to FIG. 15, an exploded side view of an interior compartment of exterior portion 1200 is shown. Spindle 1501 can extend between and through one or more of interior portion 1300 and exterior portion 1200. In some embodiments, spindle 1501 can pass through latch assembly 1410 without engaging latch assembly 1410, as described in greater detail below. Hollow shaft 1502 can be disposed over the spindle 1501 and/or spindle 1501 can pass through an approximate center of hollow shaft 1502. In some embodiments, hollow shaft 1502 can end before entering a back side of exterior portion 1200. The hollow shaft 1502 can engage latch assembly 1410 by passing through spindle opening 1503. In this way, when hollow shaft 1502 is rotated (e.g., by interior knob 1301 (FIG. 13), latch assembly 1410 can be actuated. While hollow shaft 1502 can surround all or a portion of spindle 1501, both hollow shaft 1502 and spindle 1501 can rotate independently of each other when latch assembly 1410 is in a locked configuration. In this way, exterior knob 1201 and spindle 1501 can be rotated without shifting latch assembly 1410 into an unlocked position, thereby enhancing a security of the lock. Exterior knob 1201 can be coupled and/or mechanically linked to one or more of tortional spring 1403 and tortional spring bracket 1404. When exterior knob 1201 is rotated in either direction, this motion can be transferred to tortional spring bracket 1404. Tortional spring bracket 1404 is coupled to tortional spring 1403 and/or tortional spring 1403 is immobilized on a top surface of tortional spring bracket 1404. In this way, mechanical energy is stored in tortional spring 1403 when exterior knob 1201 is rotated. When exterior knob 1201 is released, this stored mechanical energy can then be released by tortional spring 1403, thereby causing exterior knob 1201 to return to its original position.

Exterior knob 1201 can also be coupled and/or mechanically linked to gear assembly 1420. In some embodiments, spindle 1501 facilitates this coupling or mechanical linkage by being passed through one or more elements of gear assembly 1420. Gear assembly 1420 can be configured to rotate and/or charge dynamo 1405 by transferring energy generated by the rotational motion of exterior knob 1201 to dynamo 1405. Gears 1421-1424 can mechanically link and/or couple together to transfer rotational motion and energy. While gears 1421-1422 and gear 1425 are shown as spur gears, a person having ordinary skill in the art will understand that a variety of gear types can be used in gear assembly 1420. For example, helical gears, bevel gears miter gears, worm gears, screw gears, and many other types of gears can be used in gear assembly 1420. Gear 1421 can be coupled and/or mechanically linked to spindle 1501 such that, when spindle 1501 is rotated (e.g., by rotating exterior knob 1201), gear 1421 also rotates. Gear 1424 can, in turn, be coupled and/or mechanically linked to gear 1421 such that, when gear 1421 is rotated (e.g., by rotating exterior knob 1201), gear 1424 also rotates. Gear 1422 can, in turn, be coupled and/or mechanically linked to gear 1424 such that, when gear 1424 is rotated (e.g., by rotating exterior knob 1201 or via rotation of gear 1421), gear 1424 also rotates. Gear 1423 can, in turn, be coupled and/or mechanically linked to gear 1422 such that, when gear 1422 is rotated (e.g., by rotating exterior knob 1201 or via rotation of gear 1424), gear 1423 also rotates. Gear ratios among gears 1421-1424 can allow gear 1423 to rotate 10 times with a half turn of exterior knob 1201. Dynamo 1405 can comprise an electrical energy generating device capable of converting mechanical energy into electrical energy. In many embodiments, dynamo 1405 can comprise an electromagnetic motor and/or a solenoid capable of converting movement into electricity. For example, a rotational portion of dynamo 1405 can be coupled to gear 1423. In this embodiment, when gear 1423 is actuated via turning of exterior knob 1201, the rotational portion of dynamo 1405 can also rotate, thereby generating an electrical charge in an energy storage portion of a capacitor. This stored energy can then be used to power electrical elements of interior portion 1300 and/or exterior portion 1200 when onboard energy storage devices (e.g., battery 1302 (FIG. 13) or battery 1602 (FIG. 16)) are depleted or when a hardwired energy source is down.

Turning now to FIG. 16, a cutaway view showing an interior compartment of interior portion 1300 is shown. Internal components of interior portion 1300 are merely exemplary and are not limited to the embodiments presented herein. Internal components of interior portion 1300 can be employed in many different embodiments or examples not specifically depicted or described herein. Internal components of interior portion 1300 can be made from a variety of materials depending on the tolerances involved in their function. For example, internal components of interior portion 1300 can be made from metal, wood, ceramic, plastic, or some other rigid and/or semi rigid material. The internal components of interior portion 1300 can be manufactured in a number of different ways. For example, internal components of interior portion 1300 can be die cast, extruded, molded, rolled, bent, or created via some other type of industrial manufacturing process.

Interior portion 1300 can comprise circuit board 1601, battery 1602, back plate 1603, housing 1604, motor 1605, push plate 1606, tortional spring 1607, pawl 1608, partial gear 1609, spacer 1610, mounting plate 1611, key arm 1612, bolt 1613, and/or gear assembly 1620. Circuit board 1601 can be similar to circuit board 1401 (FIG. 14) in function and structure. In many embodiments, one or elements of a computer system can be split between circuit board 1401 (FIG. 14) and circuit board 1601. For example, a processor can be located on circuit board 1401 (FIG. 14) and a memory storage device can be located on circuit board 1601. Battery 1602 can be housed within battery 1302 (FIG. 13). In some embodiments, multiple batteries 1602 can be housed within battery 1302 (FIG. 13). Back plate 1603 can comprise a substantially planar bracket suitable for mounting one or more elements of interior portion 1300, supporting one or more elements of interior portion 1300, and/or coupling interior portion 1300 to a surface. The elements of interior portion 1300 can be mounted to back plate 1603 using one or more fasteners (e.g., screws, nails, anchors, etc.), adhesive (e.g., glue, epoxy, etc.), or some other mounting or coupling mechanism.

Housing 1604 can surround and protect some moving parts such as push plate 1606, a top of key arm 1612, and a gear assembly for moving key arm 1612 and/or push plate 1606. Motor 1605 can sit on top of or underneath housing 1604. The motor 1605 can be configured to drive push plate 1606 out of housing 1604 by turning the gear assembly within housing 1604. In some embodiments, motor 1605 can be activated by electrical signals from one or more of circuit board 1401 (FIG. 14) and/or circuit board 1601. For example, when a user unlocks a door using keypad 1202 (FIG. 12) or biometric authenticator 1203 (FIG. 12), one or more of circuit board 1401 (FIG. 14) and circuit board 1601 can transmit an electrical signal activating motor 1605 and extending push plate 1606 out of housing 1604. The push plate 1606 can have a substantially planar shape and have one or more central openings configured to receive gears in the gear assembly for moving key arm 1612 and/or push plate 1606. In many embodiments, push plate 1606 and/or key arm 1612 can comprise one or more teeth configured to interlock with the gears in the gear assembly for moving key arm 1612 and/or push plate 1606. In other embodiments, a terminal gear in the gear assembly can have an arm and/or an enlarged tooth configured to push one or more of push plate 1606 and/or key arm 1612 as the gear turns. Tortional spring 1607 can be configured to hold pawl 1608 in place to arrest a clockwise motion of gear assembly 1620. Pawl 1608 can be disengaged from gear assembly 1620 by extending push plate 1606 out of housing 1604. When push plate 1606 is retracted or a push plate extending force generated by motor 1605 is removed, tortional spring 1607 returns pawl 1608 to its motion arresting position.

Movement of key arm 1612 can cause a coupling and/or mechanical linkage between spindle 1501 (FIG. 15) and hollow shaft 1502 (FIG. 15), thereby allowing exterior knob 1201 (FIG. 15) to unlock the lock by retracting latch 1411. Key arm 1612 can be moved forward towards or back away from interior knob 1301. In many embodiments, moving key arm 1612 towards interior knob 1301 can release a pin within bolt 1613. Once released, the pin within bolt 1613 can drop down towards spindle 1501 (FIG. 15) and hollow shaft 1502 (FIG. 15). This pin can couple spindle 1501 (FIG. 15) and hollow shaft 1502 (FIG. 15) so that they rotate together. In this way, a lock can be unlocked and/or disengaged by rotating exterior knob 1201 (FIG. 12), which in turn rotates spindle 1501 (FIG. 15) and hollow shaft 1502 (FIG. 15). When the lock is transitioned from an unlocked configuration into a locked configuration, key arm 1612 can move back away from interior knob 1301, thereby removing the pin coupling spindle 1501 (FIG. 15) and hollow shaft 1502 (FIG. 15) together and allowing them to rotate independently again.

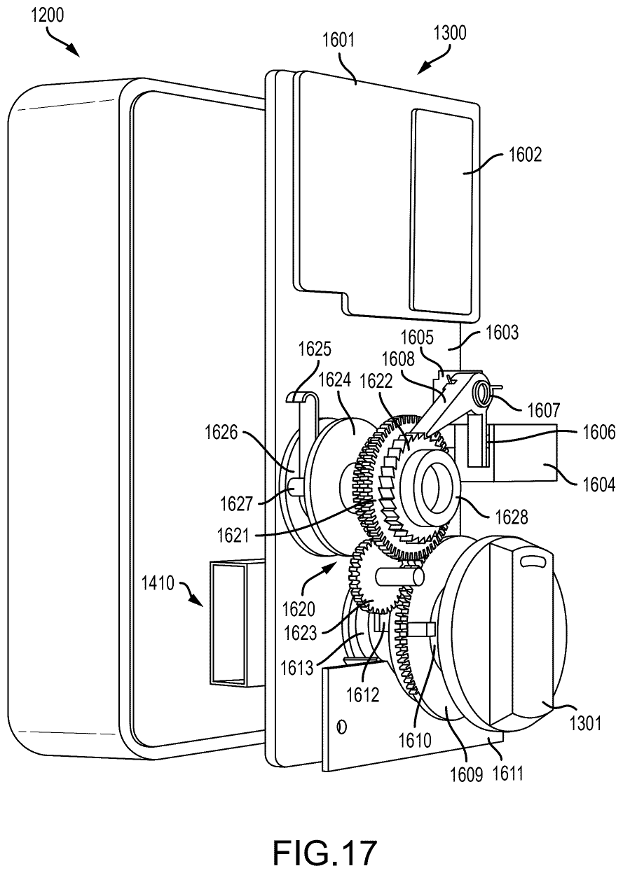

Turning now to FIG. 17, a side cutaway view of an interior compartment of interior portion 1300 is shown. Interior knob 1301 can also be mechanically linked and/or coupled to gear assembly 1620. In many embodiments, gear assembly 1620 can comprise one or more of gears 1621-1623, cog 1624, constant force spring 1625, and mounting plate 1626. Underneath interior knob 1301, spacer 1610 can create space between interior knob 1301 and partial gear 1609. Partial gear 1609 can be similar to one or more of gears 1621-1623. In some embodiments, partial gear 1609 can have teeth covering only a portion of its circumference while the remainder of the circumference has no teeth.

The rotation of gears in Gear assembly 1620 can be configured to rotate and/or charge constant force spring 1625 by transferring energy generated by the rotational motion of interior knob 1301 to constant force spring 1625. Gears 1621-1623 and cog 1624 can mechanically link and/or couple together to transfer this rotational motion and energy. While gears 1621-1623 are shown as spur gears, a person having ordinary skill in the art will understand that a variety of gear types can be used in gear assembly 1620. For example, helical gears, bevel gears miter gears, worm gears, screw gears, and many other types of gears can be used in gear assembly 1620. Gear 1621 can be coupled and/or mechanically linked to partial gear 1609 such that, when partial gear 1609 is rotated (e.g., by rotating interior knob 1301) and teeth of gear 1621 and partial gear 1609 are interlocking, gear 1621 will rotate. Gear 1621 can, in turn, be coupled and/or mechanically linked to cog 1624 such that, when gear 1621 is rotated (e.g., by rotating interior knob 1301), cog 1624 also rotates. The cog 1624 can comprise tooth 1627 and be mounted on mounting plate 1626 via a central shaft. Constant force spring 1625 can be mounted on the central shaft of cog 1624 so that the constant force spring 1625 is disposed between cog 1624 and mounting plate 1626. In many embodiments, constant force spring 1625 can be immovably coupled and/or fixed to mounting plate 1626 so that the constant power spring can flex without rotating freely on the central shaft of cog 1624. When cog 1624 is rotated (e.g., when interior knob 1301 is turned), tooth 1627 can rotate upwards into a hooked end of constant force spring 1625. As tooth 1627 pushes against the hooked end, constant force spring 1625 is coiled tighter, thereby producing an opposite force in constant force spring 1625 against tooth 1627. When interior knob 1301 is released, the opposite force generated by constant force spring 1625 reverses the rotational movement of gear assembly 1620, thereby extending latch 1411 (FIG. 14) and locking the lock. Using constant force spring 1625 to extend latch 1411 (FIG. 16) can extend a lifetime of batteries 1302 (FIG. 13) and/or 1602, thereby allowing a lock to remain operational for a longer period.

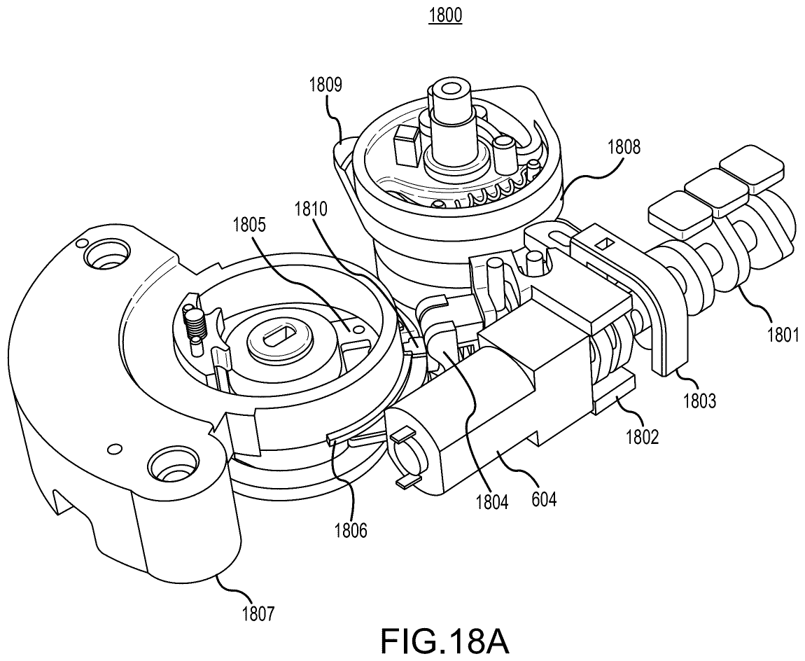

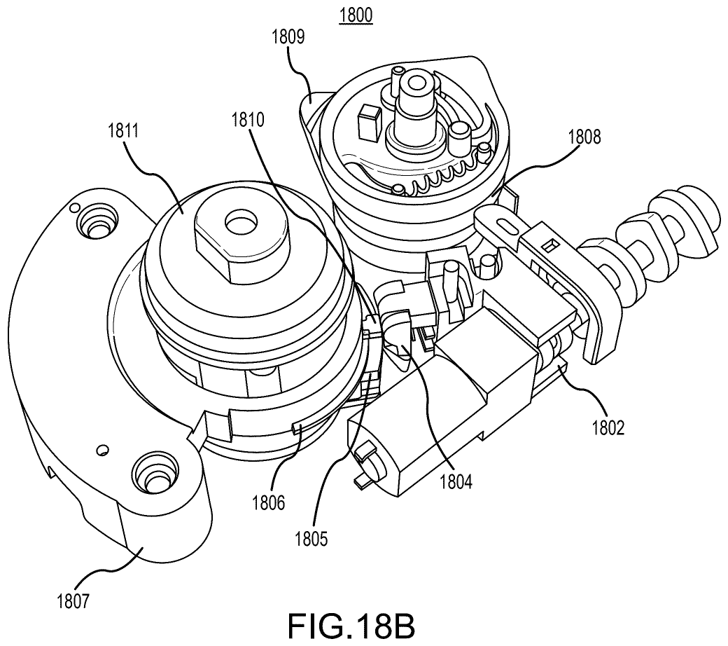

Turning now to FIG. 18A, a cutaway view of a drivetrain 1800 for an interior portion of a lock is shown. Drivetrain 1800 can be used in place of various components of interior portion 200 (FIG. 2) and/or interior portion 1300 (FIG. 13) in order to assist in actuating a lock. For example, one or more components of drivetrain 1800 can be used in place of one or more of push plate 506 (FIG. 5), mounting bracket 508 (FIG. 5), pawl 601 (FIG. 6), gears 602-603 (FIG. 6), key arm 605 (FIG. 6), and/or key arm receiver 607 (FIG. 6), motor 1605 (FIG. 16), push plate 1606 (FIG. 16), tortional spring 1607 (FIG. 16), pawl 1608 (FIG. 16), partial gear 1609 (FIG. 16), spacer 1610 (FIG. 16), mounting plate 1611 (FIG. 16), key arm 1612 (FIG. 16), and/or gear assembly 1620 (FIG. 16). Motor 604 can be configured to rotate camshaft 1801. Rotation of camshaft 1801 can push clutch 1802 towards an interior knob (e.g., interior knob 201 (FIG. 2) or interior knob 1301 (FIG. 13)). Continued rotation of the camshaft 1801 and/or rotation in an opposite direction can push clutch 1802 away from the interior knob (e.g., interior knob 201 (FIG. 2) or interior knob 1301 (FIG. 13). Rotation of the camshaft 1801 can also actuate pawl 1803 towards and/or away from spring peg 1808, thereby arresting rotation of spring peg 1808 when pawl 1803 comes in contact with a protrusion 1809 of the spring peg 1808.

Turning now to FIG. 18B, clutch 1802 can be coupled to hook 1804. When clutch 1802 moves towards an interior knob, hook 1804 can push pin 1810 into an aperture in spindle 1811. When clutch 1802 moves away from an interior knob, hook 1804 can allow pin 1810 to be removed from an aperture in spindle 1811. Movement of pin 1810 into an aperture can allow coupling and/or mechanical linkage between spindle 1811 and a hollow shaft (e.g., hollow shaft 402 (FIG. 4) or hollow shaft 1502 (FIG. 15)). This movement of pin 1810 into the aperture can then allow an exterior knob to unlock the lock by retracting the latch. When pin 1810 is engaged with an aperture of spindle 1811 and rotated by an external knob, the pin 1810 will pass over protrusion 1806 on mounting bracket 1807. In this way, a lock will remain unlocked until an interior knob is returned to an original (e.g., locked) position.

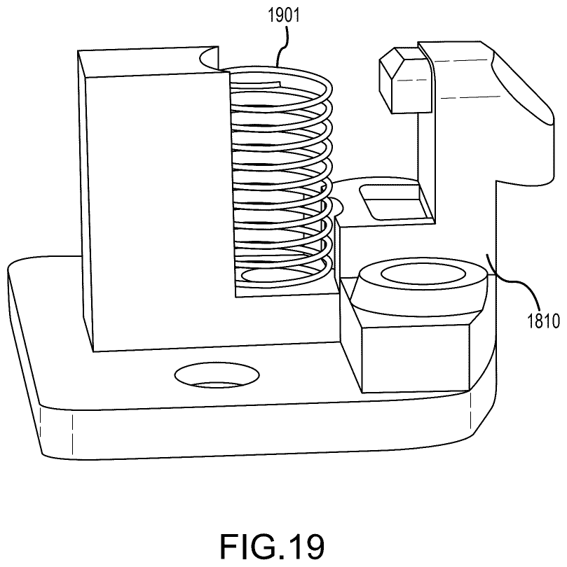

Turning now to FIG. 19, a cutaway view showing a portion of drivetrain 1800 is shown. When pin 1810 is removed from above protrusion 1806 (FIGS. 18A and 18B), spring 1901 can push pin 1810 away from an interior knob. When hook 1804 (FIGS. 18A and 18B) is not being pushed by clutch 1802 (FIGS. 18A and 18B), the pushing of pin 1810 by spring 1901 removes pin 1810 from an aperture in spindle 1811 (FIGS. 18A and 18B), thereby disengaging spindle 1811 (FIGS. 18A and 18B) from a hollow shaft. This, in turn, disengages an exterior knob and locks the lock.

Although automatic locks have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-19 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A door lock for locking biased latch bolts, comprising:
an exterior portion;
a latch assembly coupled to the exterior portion; and
an interior portion coupled to the latch assembly, the interior portion comprising a constant power spring configured to actuate the latch assembly.

2. The door lock of claim 1, wherein:
the exterior portion comprises an exterior knob;
the interior portion comprises an interior knob;
the door lock further comprises a spindle extending from the exterior knob, through the latch assembly, and to the interior knob and mechanically linked to the constant power spring; and
turning the exterior knob or the interior knob rotates the spindle and charges the constant power spring to actuate the latch assembly.

3. The door lock of claim 2, wherein the interior portion further comprises a cog mechanically linked to the interior knob or the exterior knob, wherein rotating the cog charges the constant power spring.

4. The door lock of claim 3, wherein the cog comprises a tooth configured to couple a hooked end of the constant power spring and rotating the cog causes the tooth to couple the hooked end of the constant power spring, thereby coiling the constant power spring.

5. The door lock of claim 4, wherein the coiling of the constant power spring produces a force in an opposite direction of the rotating the cog.

6. The door lock of claim 2, wherein the exterior portion further comprises:
a gear assembly mechanically linked to the exterior knob; and
a dynamo mechanically linked to the gear assembly.

7. The door lock of claim 6, wherein the dynamo comprises an electromagnetic motor configured to convert rotational movement into energy.

8. The door lock of claim 7, wherein the energy created by the dynamo is stored in a capacitor.

9. The door lock of claim 8, wherein at least one of the exterior portion and the interior portion comprise at least one of a circuit board, a motor, a biometric authenticator, an indicator light, and a keypad.

10. The door lock of claim 9, wherein the capacitor provides electrical power to at least one of the circuit board, the motor, the biometric authenticator, the indicator light, and the keypad.

11. A door lock using a motor and blocking system, comprising:
an exterior portion comprising an exterior knob;
a latch assembly coupled to the exterior portion;
an interior portion coupled to the latch assembly and comprising:
the motor; and
a key arm mechanically linked to the motor; and
a spindle extending from the exterior portion to the interior portion and mechanically linked to the key arm and the latch assembly, wherein:
when engaged, the key arm allows the spindle to be turned by the exterior knob without actuating the latch assembly; and
when disengaged, the key arm allows the spindle to be turned by the exterior knob and actuate the latch assembly.

12. The door lock of claim 11, wherein:
the door lock further comprises a hollow shaft disposed over the spindle and mechanically linked to the latch assembly;
the interior portion further comprises an interior knob;
the spindle extends from the exterior knob, through the latch assembly, through the hollow shaft, and to the interior knob; and
turning the interior knob rotates the hollow shaft and actuates the latch assembly regardless of whether the key arm is engaged or the key arm is disengaged.

13. The door lock of claim 11, wherein the key arm is engaged and disengaged by the motor.

14. The door lock of claim 12, wherein, when disengaged, the key arm moves away from the interior knob.

15. The door lock of claim 12, wherein, when disengaged, the key arm releases a pin that drops towards and couples the spindle and the hollow shaft together.

16. The door lock of claim 14, the interior portion further comprising a gear assembly.

17. The door lock of claim 16, wherein the gear assembly comprises:
a partial gear coupled to the interior knob;
a gear mechanically linked to the partial gear and configured to be rotated upon rotating of the interior knob; and
a spring housing coupled to the gear and configured to be rotated upon rotating of the gear.

18. The door lock of claim 17, the spring housing further comprising:
a first spring peg coupled to the interior portion;
a second spring peg; and
a tortional spring, wherein a first end of the tortional spring is coupled to the first spring peg and a second end of the tortional spring is coupled to the second spring peg.

19. The door lock of claim 18, wherein upon rotation of the spring housing the second spring peg is rotated, thereby stretching the tortional spring.

20. The door lock of claim 19, wherein the rotation of the spring housing causes a protrusion to extend outwardly from the spring housing and engage a pawl, thereby preventing the gear assembly from rotating.
